(19) United States
(12) Patent Application Publication
(10) Pub. No.: US 2004/0037768 A1
(43) Pub. Date: Feb. 26, 2004

(54) Method and system for on-site generation and distribution of a process gas

(76) Inventor: Robert Jackson, Burnet, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/038,745

(22) Filed: Jan. 2, 2002

Related U.S. Application Data
(60) Provisional application No. 60/333,405, filed on Nov. 26, 2001.

(51) Int. Cl. C01B 7/19

(52) U.S. Cl. 423/500

(57) ABSTRACT

A system and method for on-site generation and distribution of a process gas are disclose, one embodiment of the system comprising a process gas generation cabinet, wherein the process gas generation cabinet comprises a housing, encompassing a process gas generator, and an exhaust and abatement system. The cabinet housing can further comprise one or more input vents to direct air to the process gas generator; a normal exhaust output port; and, an emergency exhaust output port. The exhaust and abatement system can further comprise an exhaust channel; a normal operating channel coupled to the normal exhaust output port and the exhaust channel, wherein the normal operating channel further comprises a normal operating valve; an emergency channel coupled to the emergency exhaust output port of the cabinet housing and to the exhaust channel, wherein the emergency channel further comprises an emergency exhaust valve and an absorbent packed material; and a process gas sensor located upstream from the normal operating valve, wherein the process gas sensor is operable to close the normal operating valve and open the emergency exhaust valve if process gas levels in the cabinet housing exceed a preset level. The process gas can be, for example, fluorine.

### RELATED APPLICATIONS

This application claims priority under 35 U.S.C. § 119(e) to U.S. patent application No. 60/333,405 entitled “System and Method for Generating a Non-Ozone-Depleting Material” by Robert Jackson, filed Nov. 26, 2001, which is incorporated by reference as if set forth in its entirety herein.

### TECHNICAL FIELD OF THE INVENTION

This invention relates generally to fabrication process materials and, more particularly, to systems and methods for on-site generation and distribution of a fabrication process gas.

### BACKGROUND OF THE INVENTION

Fabrication processes can, and typically do, require the use of hazardous materials. The generation, storage and delivery of these hazardous materials is a concern in fabrication facilities because of their dangerous nature and because of the large amounts of the materials typically required to be stored on site. Further, the increasing demand for efficient fabrication processes and fabrication process technology call for the use of ever more exotic and hazardous materials. For example, some fabrication processes use nitrogen trifluoride (NF₃) gas to remove undesirable contaminants associated with deposition processes. Some conventional fabrication deposition processes comprise depositing layers of material through either chemical vapor deposition (“CVD”) or physical vapor deposition (“PVD”) of sometimes hazardous materials. Other fabrication processes that may use gaseous materials such as NF₃ may include etch processes. These processes all rely on the reactive (corrosive) properties of a gas such as NF₃, either for direct etching of a material to form a pattern, or for post-process removal of contaminants remaining from a fabrication process. CVD reactor chamber cleaning has historically been accomplished using ozone-depleting gases such as NF₃, hexafluoroethane (C₂F₆), and others that are packaged in high-pressure gas cylinders. The risk of accidents or gas release from cylinders is high, and the change-out of depleted cylinders is frequent, time-consuming, and dangerous.

Further, some commonly used gases, such as NF₃, are in relatively limited supply and consequently are available only at high cost. One solution that moves away from the use of NF₃ is to use a fluorine generator to provide fluorine gas that can then be provided to a fabrication tool. The production of fluorine via electrolysis and the use of so-called fluorine cells are a proven technology and are well known to those in the art. Fluorine cells can be used to produce fluorine by the electrolysis of hydrogen fluoride (HF) and a salt. Fluorine is produced at the anode of a fluorine generation cell in direct proportion to the current applied to the anode, with a typical efficiency of approximately 95%. The fluorine produced by a fluorine cell is typically passed through an inorganic, nonvolatile absorbent material to remove residual hydrogen fluoride and then through a filter to remove particulates.

Typically, fluorine produced from a fluorine cell is directed toward a sodium fluoride (“NaF”) trap to remove the residual hydrogen fluoride. In some cases, there can be as much as 5% excess hydrogen fluoride mixed with the fluorine produced from the fluorine generation cells. The NaF in an NaF trap reacts with hydrogen fluoride, but allows the fluorine to flow through without interruption. Typical prior art fluorine generation cells provide a fluorine and hydrogen fluoride mixture to a single large NaF trap. This can lead to inefficiencies and delays in a fabrication process because as the NaF trap absorbs hydrogen fluoride it will eventually become saturated and, consequently, will need to be shut down and regenerated. Hydrogen fluoride is removed from the fluorine gas because it is corrosive to stainless steel and other materials and typically the piping downstream of the fluorine generator is stainless steel. However, while the NaF trap is placed out of service to be regenerated, fluorine cannot be produced and delivered to the fabrication tools, thus halting the fabrication process.

Sodium fluoride traps thus remove the hydrogen fluoride to provide pure fluorine, but eventually they must be placed out of service and regenerated to continue to effectively remove hydrogen fluoride. Prior art methods for regenerating an NaF trap involve shutting down the fluorine generation cell, heating the sodium fluoride trap to approximately 300° C., purging the trap with nitrogen, and blowing the hydrogen fluoride off of the sodium fluoride inside of the NaF trap. The trap can then be returned to service and the fluorine generation cell can resume operation. However, in the semiconductor industry, a continuous fabrication run is extremely important and space in the fabrication facility is of major concern. Prior art methods, which require shutting down of the entire fabrication process and that require significant amounts of floor space, are not cost-effective solutions for the requirements of today's fabrication industry. Prior art NaF traps are typically very large and require significant amounts of floor space to install and operate them. Further, prior art sodium fluoride traps are typically purged with nitrogen during the regeneration process. Purging with nitrogen can introduce contaminants that can dilute the fluorine delivered to fabrication tools. Production efficiency and the purity of semiconductor devices produced can thus be adversely affected.

Not only are currently existing fluorine systems very large systems, but because fluorine is a highly toxic gas, they also require complex treatment (abatement) systems capable of containing the accidental release of all on-site fluorine gas. These treatment systems are required to process all exhaust ventilation discharged from gas cabinets, exhausted enclosures, and gas rooms. Current treatment systems incorporate individual and independent continuous exhaust systems. The most common treatment systems for fluorine generation processes include scrubbing (with water or a caustic solution), direct burning of the exhaust with a fuel such as methane or propane, chemical reaction with solid disposal agents such as charcoal, aluminum, limestone, lime and/or soda lime, and/or reaction with superheated steam. Such prior art treatment systems, however, are not space or cost efficient because of the considerable utility, space requirements, and up-front installment expenses associated with them. Further, standard procedures for handling fluorine abatement usually require separate and independent abatement systems for each fluorine generator, further increasing costs to a fabrication plant operator.

A semiconductor fabrication facility typically employs two types of abatement systems. First, a house abatement system is employed that is capable of containing and abating operational releases of chemistry and gases that are below permissible hazard levels. Second, dedicated abatement systems at specific fabrication tools are used to contain accidental gas releases above permissible hazard levels. The dedicated abatement systems are specially designed for the specific hazard(s) of the tool(s) they service. The dedicated abatement systems can generally handle one or multiple tools and are typically sold and housed independently of the tool(s) they service. A single exhaust flow path is typically provided for an effluent gas stream to pass through, which is through the abatement system.

However, the general belief is that absorbent materials used for abatement are inferior to other treatment methods because their efficiency rapidly decreases due to the formation of a surface coating of reaction products. A continued flow of air through a fluorine abatement system will expose the absorbent material in the fluorine abatement system to moisture and other contaminants, which can break down the absorbent material. Therefore, the less air flowing through the fluorine abatement system, the lower the required maintenance and change-out of the absorbent material.

Fluorine generators are typically contained in special rooms that exhaust to an independent abatement system located outside the room and that uses one or more of the different treatment methods discussed above to abate fluorine. The abatement units are large, expensive, and independent of the fabrication tools. In the prior art, a fluorine generation system will thus typically have a single exhaust outlet from the inside of the generator housing directly to a house exhaust, which is in turn connected to the independent abatement system. After passing through the abatement system, the treated air is exhausted to the outside atmosphere. The prior art abatement systems use large absorbers that are designed to absorb all fluorine produced and maintained on-site by a very large fluorine generator. All the exhaust from a fabrication facility is directed through the abatement system absorbers, regardless of whether it is contaminated. This is in part necessary because in prior art fluorine generation systems, large amounts of fluorine were typically dumped into the generation room when, for example, a sodium fluoride trap is regenerated. All of the air in the generation room would then have to be exhausted through the fabrication facility abatement system.

Continuously exhausting all of the air from a fluorine generation room through an abatement system, as well as having to design into the fluorine abatement system the capacity to abate all of the fluorine that a very large fluorine generator is capable of generating, makes the airflow capacity in a fabrication facility one of the most expensive commodities for the facility. For example, maintaining the environment in a controlled fabrication process room (in which humidity and temperature are regulated), is expensive. If all of the process room air must be exhausted through a house exhaust system and through a fluorine abatement system, the energy expended to control the process room environment is wasted. Both humidity and temperature are typically tightly controlled and thus must be maintained even when dumping all of the air into the house exhaust system. This can be a very expensive process, not only in terms of maintaining a process room environment, but also in terms of the abatement system lifetime.

In order for an absorbent in an abatement system to absorb an element, such as fluorine, the absorbent must be activated (dry). If air is continually run through the absorbent, the humidity in the air will cause the absorbent to saturate more rapidly than if exhaust air is run through it only when fluorine contamination is present. The absorbent packaging will absorb water, fluorine and anything else in the air that can be absorbed. This is because the absorbent materials are typically not specific to fluorine. For example, aluminum oxide, a commonly used absorbent material, will not allow fluorine to pass through it (it instantly reacts with fluorine), but it will also react with other materials. In prior art systems, exhaust air is continuously run through the absorbent, which requires the frequent regeneration of the absorbent traps, even if the air flowing through the traps contains no fluorine. Continuous flow prior art abatement systems are thus expensive and inefficient to operate and maintain.

Further, prior art fluorine generation systems typically require, for a full fabrication facility bulk distribution system (for example, to feed 50 fabrication tools), a very large on-site fluorine storage tank. Storing large amounts of fluorine on-site is a very important safety concern because of fluorine's corrosive nature. For example, bulk distribution of fluorine to a facility can require many cylinders of fluorine gas to be stored on-site, which can be dangerous to handle beyond the gas that they contain. This is a large amount of fluorine to maintain on site, because prior art abatement systems must have the capacity to treat the total amount of on-site fluorine in the event of a breach. The abatement requirements for such a large amount of fluorine are significant. A further disadvantage of using one large fluorine generator to feed multiple fabrication tools is that the gas feed lines to the tools must be maintained at a positive pressure. This is because the single large fluorine storage vessel is the only source for multiple feed lines. Therefore, if a leak occurs in a fluorine gas feed line, all of the fluorine gas in the storage tank may potentially push through the leak and into the facility space through which the line is running. As previously discussed, the facility abatement system must be capable of handling such a leak, adding to the abatement system cost. Further, a leak could cause the shutdown of all fabrication tools because it can cause the shutdown of the large bulk storage unit.

Another problem associated with the generation of a process gas such as fluorine, is the use of hazardous liquids, which require secondary containment, both in transportation and for on-site storage. Fluorine generators typically use an electrolyte in a liquid stage, during normal operation, that requires secondary containment to protect against a leak. A standard prior art secondary containment system consists of constructing a containment dike around the affected equipment with the containment dike capable of containing 110% of the hazardous liquid. The current methods for secondary containment are both costly and difficult to manufacture because they require locating the entire fluorine generator inside a secondary containment, such as a dike. If, for example, an electrolyte breach occurs, it will therefore, escape from the fluorine generator, but will not get past the secondary containment. However, constructing a secondary containment around a very large piece of equipment can be expensive and difficult. Further, a typical fluorine generation cell weights approximately 1,000 pounds. If a cabinet containing the fluorine generator is located behind a secondary containment, such as the dike discussed above, the fluorine generation cell will require heavy equipment to maneuver it into place inside the cabinet. For example, a forklift may be required, which requires significant maneuvering room (e.g., approximately ten feet) around the fluorine generator cabinet. Such open spaces are expensive to maintain in a fabrication facility.

The prior art generation, storage, and delivery of process gases, and in particular of highly reactive and corrosive process gases such as fluorine, therefore require overly expensive, complicated and difficult to maintain generation, abatement, containment, exhaust, and distribution systems.

### SUMMARY OF THE INVENTION

Therefore, there is a need for a method and system for on-site generation and distribution of a process gas having redundant process gas generation cells and contaminant traps, such that at least one of each can be operating at any given time to supply a fabrication process.

A further need exists for a method and system for on-site generation and distribution of a process gas that can be housed in a compact generator cabinet having a dual exhaust system to avoid continuous airflow through an abatement system's absorbent material, thus avoiding premature degradation of the absorbent material.

Still further, a need exists for a method and system for on-site generation and distribution of a process gas with the ability to provide an on-demand supply of the process gas under negative pressure. Such a system can eliminate the need for a large central process gas storage tank, and the requisite abatement system for such a tank, and increase safety in the event of a process gas supply line leak.

An even further need exists for a method and system for on-site generation and distribution of a process gas having individual compressors and storage tanks for each fabrication tool, such that the process gas can be provided at a positive pressure to the fabrication tool with the process gas supply line under negative pressure.

Still further, a need exists for a method and system for on-site generation and distribution of a process gas having a mobile, compact and self-contained secondary containment system for hazardous liquids associated with a process gas generation cell.

In accordance with the present invention, a method and system for on-site generation and distribution of a process gas are provided that substantially eliminate or reduce the disadvantages and problems associated with prior art methods and systems for generation and distribution of process gases, including the problems of hazardous liquid containment, large and complex abatement systems, non-redundant generation cells, and large and expensive bulk distribution systems.

More specifically, the present invention provides a method and system for on-site generation and distribution of a process gas, one embodiment of the system comprising a process gas generation cabinet, wherein the process gas generation cabinet comprises a housing, encompassing a process gas generator, and an exhaust and abatement system. The cabinet housing can further comprise one or more input vents to direct air to the process gas generator; a normal exhaust output port; and, an emergency exhaust output port. The exhaust and abatement system can further comprise an exhaust channel; a normal operating channel coupled to the normal exhaust output port and the exhaust channel, wherein the normal operating channel further comprises a normal operating valve; an emergency channel coupled to the emergency exhaust output port of the cabinet housing and to the exhaust channel, wherein the emergency channel further comprises an emergency exhaust valve and an absorbent packed material; and a process gas sensor located upstream from the normal operating valve, wherein the process gas sensor is operable to close the normal operating valve and open the emergency exhaust valve if process gas levels in the cabinet housing exceed a preset level. The process gas can be, for example, fluorine.

A technical advantage of the embodiments of the method and system of this invention for on-site generation and distribution of a process gas is that they can provide redundant process gas generation cells and contaminant traps, such that at least one of each can be operating at any given time to supply a fabrication process.

Another technical advantage of the embodiments of this invention for on-site generation and distribution of a process gas is the ability to house a process gas generation system in a compact generator cabinet having a dual exhaust system to avoid continuous airflow through an abatement system's absorbent material.

Still another technical advantage of the embodiments of the method and system of this invention for on-site generation and distribution of a process gas is the ability to provide an on-demand supply of the process gas under negative pressure.

A further technical advantage of the embodiments of the method and system of this invention for on-site generation and distribution of a process gas is the ability to provide individual compressors and storage tanks for each fabrication tool, such that the process gas can be provided at a positive pressure to the fabrication tool with the process gas supply line under negative pressure.

Yet another technical advantage of the embodiments of the method and system of this invention for on-site generation and distribution of a process gas is providing a mobile, compact and self-contained secondary containment system for hazardous liquids associated with a process gas generation cell.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 is a simplified block diagram of one embodiment of the system and process flow for on-site generation and distribution of a process gas of the present invention;

FIG. 2 is a simplified block diagram of another embodiment of the method and system of this invention for providing on-site generation and distribution of a process gas at or near a fabrication facility;

FIG. 3 is a more detailed block diagram of an embodiment of the system for on-site generation and distribution of a process gas of the present invention;

FIG. 4 illustrates one embodiment of a process gas generation cabinet 200 of this invention incorporating a dual exhaust system;

FIG. 5 illustrates the air flow through cabinet 200 under an emergency breach situation;

FIG. 6 is a simplified, diagrammatic representation of a bulk distribution system for fluorine, or other process gas, in accordance with the teachings of this invention;

FIG. 7 shows one embodiment of a secondary containment system (cart) 400 housing a process gas generation cell 14;

FIG. 8A shows a view and front face elevation of one embodiment of cabinet 200 of this invention;

FIG. 8B shows a front view of the interior of one embodiment of cabinet 200 of this invention;

FIG. 8C shows a sectional side view of one embodiment of cabinet 200 of this invention;

FIG. 9A shows a plan view from the top of one embodiment cabinet 200 of this invention;

FIG. 9B shows a plan on top of the cabinet with the top of the enclosure removed to show the interior of cabinet 200;

FIG. 9C shows a plan on the process gas compression, purge, and cooling systems of one embodiment of cabinet 200 of this invention; and

FIG. 9D shows a plan on the process gas generation cells 14, filters, and sodium fluoride traps 32 of one embodiment of cabinet 200 of this invention.

### DETAILED DESCRIPTION OF THE INVENTION

Preferred embodiments of the present invention are illustrated in the FIGUREs, like numerals being used to refer to like and corresponding parts of the various drawings.

The embodiments of the method and system of the present invention can provide the ability to generate a process gas, such as fluorine, at or near a fabrication facility more efficiently and at a lower cost than prior art methods. The embodiments of this invention can thus reduce or eliminate the hazards associated with the transportation, storage and handling of cylinders containing toxic gas under high pressure, as is currently required by prior art methods and systems for generation and distribution of process gases. The embodiments of the method and system of the present invention can provide a compact and fully automated (one-button) system for generating high-purity process gases on demand at or near a fabrication facility. For example, the embodiments of this invention can generate fluorine gas only as required by one or several fabrication tools, such as chemical vapor deposition (“CVD”) reactors. The “supply only when needed” ability of the embodiments of this invention can dramatically reduce the amount of on-site process gas required when compared to prior art systems that maintain large inventories of process gas cylinders. Further, embodiments of this invention can reduce or eliminate disadvantages and problems of prior art systems for containment of toxic liquids associated with the generation of a process gas and can reduce the abatement system requirements needed to safely treat generated process gases in the event of a process gas leak.

Embodiments of the present invention can comprise one or more fluorine generators producing fluorine through the electrolysis of hydrogen fluoride (HF) in an electrolytic salt. This process is extremely efficient and can produce high-purity fluorine and hydrogen, with the fluorine directed to fabrication tools and the hydrogen directed to an exhaust system. Further, the embodiments of this invention are capable of delivering a process gas, such as fluorine, at both sub-atmospheric (negative) and super-atmospheric (positive) pressure. Embodiments of the present invention are also capable of producing varying amounts of a process gas on demand. A typical on demand production amount can be in the range of 125 to 700 grams per hour. The embodiments of the method and system of this invention can provide for in-fab, on-tool, or fab-wide generation and distribution of a process gas. Embodiments of the present invention can also comprise a fully automated programmable logic controller (“PLC”) controlled system with a touch-screen operator interface. The interface can be a hardware-based interface for faults and alarms. Further, a PLC embodiment of this invention can be capable of interfacing with a process tool and can be housed in its own compact, self-contained cabinet.

The embodiments of the system and method of the present invention can comprise a fluorine generator cabinet having multiple fluorine cells. In one embodiment, the fluorine generator cabinet can have two fluorine cells, the idea being that at least one of the fluorine cells is in operation at all times, while one or more of the other cells is regenerating. This configuration provides system redundancy so that process gas generation can be maintained in the event a cell requires maintenance or in the event of a cell failure.

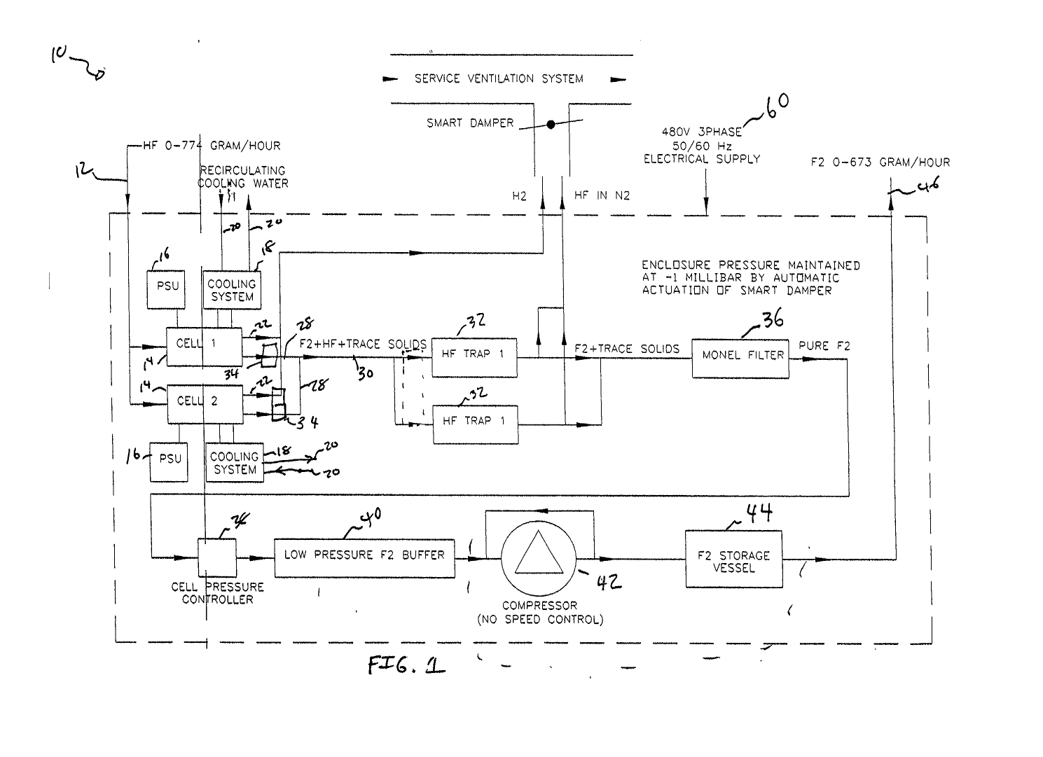

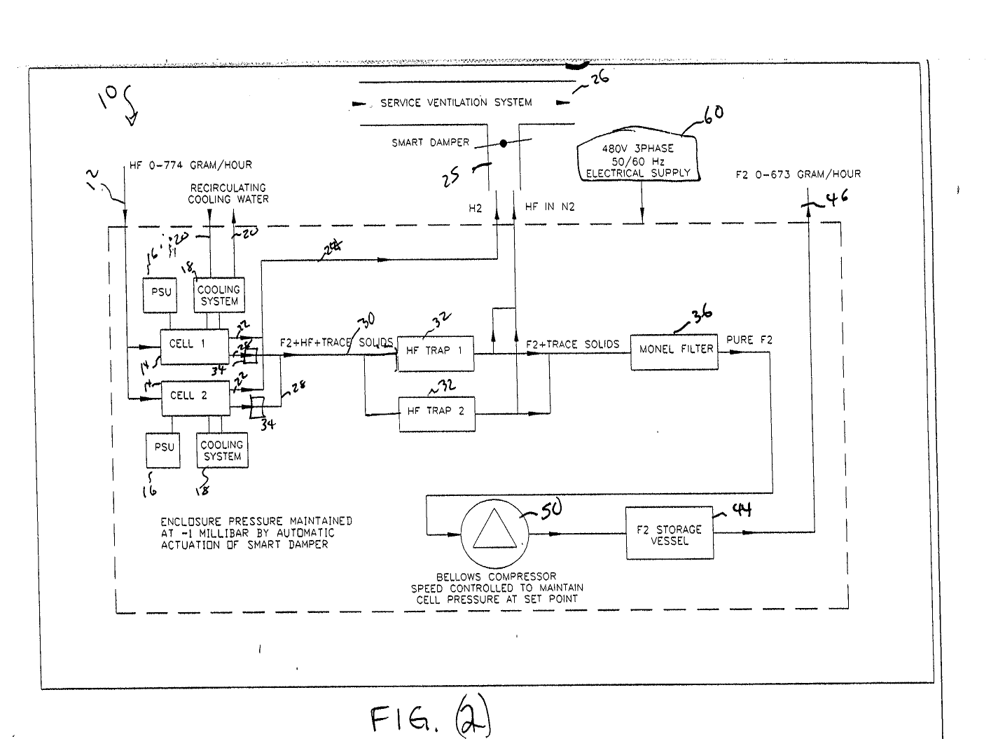

FIG. 1 is a simplified block diagram of one embodiment of the system and process flow for on-site generation and distribution of a process gas of the present invention. Process gas generation system 10 includes input supply line 12 to process gas generation cells 14. In one embodiment of the present invention, input supply line 12 can be used to supply hydrogen fluoride gas to an electrolyte within process gas generation cells 14. The process gas generated by process gas generation cells 14 can be fluorine and the electrolyte within process gas generation cells 14 can be HCl potassium bichloride and hydrogen fluoride. Hydrogen Fluoride bonds with the potassium bichloride to produce fluorine gas and trace amounts of hydrogen. Some percentage of hydrogen fluoride is also output from process gas generation cells 14 with the fluorine and hydrogen.

Each process gas generation cell 14 can be coupled to a pressure sensing unit 16 and a cooling system 18. Pressure sensing unit 16 monitors the pressure within a process generation cell 14. Cooling system 18 provides cooling to its respective process generation cell 14 using recirculating cooling water through cooling water lines 20.

Hydrogen is output from each process gas generation cell 14 along hydrogen output line 22. Combined hydrogen output header 24 is coupled to and receives hydrogen from each hydrogen output line 22. Hydrogen output header 24 is coupled to exhaust system 25. Hydrogen is routed to exhaust system 25 and then to service ventilation system 26, which exhausts the hydrogen to the outside atmosphere.

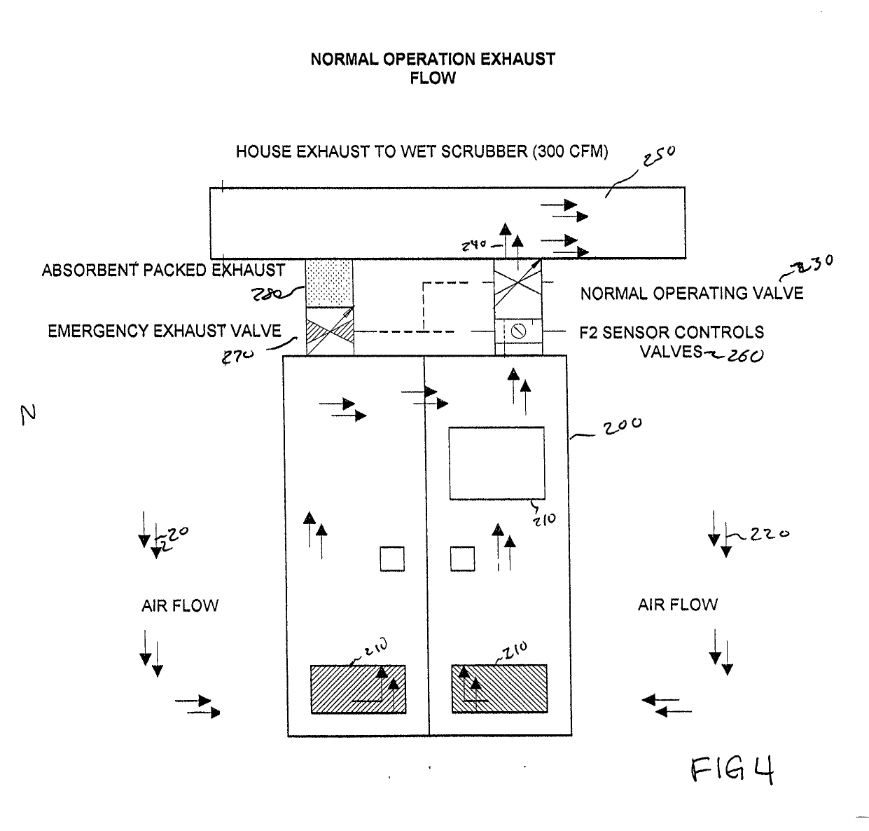

Fluorine, including trace amounts of hydrogen fluoride and trace solids, is output from process gas generation cells 14 along process gas output lines 28 to a combined process gas output header 30. Each process gas generation cell 14 can further comprise an output manifold 34, shown as a separate unit in FIGS. 1, 2, and 3, but which can be integral to a process gas generation cell 14. Process gas (fluorine) flows through an output manifold 34 before being directed to combined gas output header 30. As is more clearly shown in FIG. 3, process gas generation system 10 can further comprise various valves operable in various open/closed combinations, to direct process gas from each manifold 34 to one or another (or to multiple) NaF traps 32. Process gas output header 30 is coupled as an input to each of multiple sodium fluoride traps 32. Although FIG. 1 shows only two sodium fluoride traps 32, embodiments of this invention can comprise multiple NaF traps, as may be required by a given application. The process gas (fluorine) is thus output from process gas generation cells 14 to one or another sodium fluoride trap 32 through a manifold 34. Manifolds 34 can be used to route a process gas to either of sodium fluoride traps 32, such that if either NaF trap is out of service for regeneration or repair, the other can receive process gas from either process gas generation cell 14.

The sodium fluoride in NaF traps 32 reacts with the hydrogen fluoride trace amounts to trap the hydrogen fluoride and remove it from the process gas mixture. By using multiple contaminant traps (in the embodiment of FIG. 1, sodium fluorine traps 32), the embodiments of the present invention can avoid the costly shutdowns of fluorine generation system 10 required by prior art methods to regenerate or maintain the containment traps. Sodium fluorine traps 32 of the present invention are contemplated to be small and compact units. In operation, one sodium fluoride trap 32 is always on-line, with the other NaF trap 32 (or other ones) regenerating or being maintained. Manifolds 34 in combination with valves and valve control systems (as known in the art), are operable to route process gas from a fluorine generation cell 14 to an operable NaF trap 32, and thus keep generation system 10 operational.

While the description herein is made with reference to fluorine gas generation, it is contemplated that other process gasses can be generated using the embodiments of the method and system of this invention. In operation, the fluorine provided to a sodium fluoride trap 32 contains trace amounts of hydrogen fluoride, which are removed by the sodium fluoride trap 32. Eventually the sodium fluoride in the outline sodium fluoride trap 32 can become saturated by the removed hydrogen fluoride. The NaF trap 32 must then be regenerated to return it to operation. When this occurs, process gas generation system 10 can be configured to route process gas to another NaF trap 32, e.g., a secondary sodium fluoride trap 32. Process gas generation system 10 can thus continue to operate while the first sodium fluoride trap 32 is regenerated. Regeneration of a sodium fluoride trap 32 can comprise heating the sodium trap to approximately 300 degrees, generating a vacuum at the NaF trap 32 to remove impurities, and then placing the NaF trap 32 in standby mode. In a similar manner, when a next sodium fluoride trap 32 becomes saturated, the system can be switched back to the first NaF trap 32 while the next NaF trap 32 is regenerated. The system can then switch back and forth between NaF traps 32 without interrupting the process gas flow. Embodiments of the present invention can include, as part of a control mechanism, a switching mechanism to insure that fluorine gas is directed to an operational sodium fluoride trap 32 at any given time. Process gas generation system 10 can further comprise a control platform and switching mechanism that can detect when one sodium fluoride trap is full and switch the system to a standby trap.

As part of regenerating an NaF trap 32, embodiments of the method and system of this invention can purge the NaF trap 32, once heated, by generating a vacuum on the trap. This process is unlike that of prior art systems that purge the NaF trap 32 with nitrogen, which can introduce contaminants to the process gas and thus dilute the process gas provided to a fabrication tool. Providing a pure fluorine gas product (or any other process gas) to a fabrication tool is very important to the semiconductor industry because even tiny amounts of a contaminant can create adverse results in a fabricated product. Embodiments of this invention avoid purging sodium fluoride traps 32 with nitrogen to avoid introducing impurities to the process gas, and can instead pull a vacuum on an NaF trap 32 to remove hydrogen fluoride impurities from the sodium fluoride trap 32.

Embodiments of the present invention can also comprise a nitrogen purge mechanism (as will be shown in greater detail as part of FIG. 3). A nitrogen purge can be used when all of the sodium fluoride traps 32 have reached the end of their useful lives, or when performing a scheduled maintenance on the overall process gas generation system 10. When all of the sodium fluoride traps 32 are replaced, it is desirable to purge process gas generation system 10 to remove any contaminants introduced while the system piping was open.

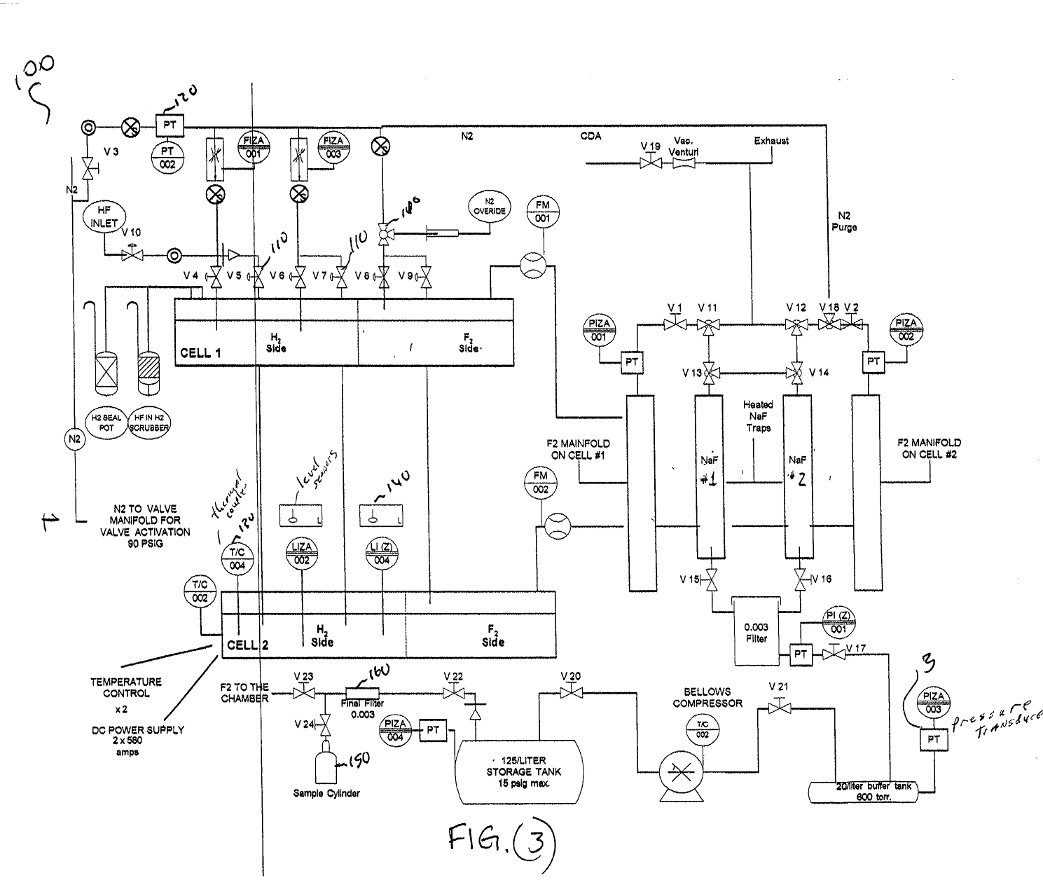

Returning now to FIG. 1, at the output of sodium fluoride traps 32, fluorine gas, including small amounts of trace solids, is output through output filter 36 and provided to either a low pressure buffer tank 40 or directly to a compressor. Both of these embodiments are shown, respectively, in FIGS. 1 and 2. As shown in FIG. 1, filtered fluorine gas is output from filter 36 and forwarded to cell pressure controller 38. Cell pressure controller 38 can cycle process gas generation cells 14 on and off based on process gas demand as measured at the input to low pressure buffer tank 40. Fluorine gas is provided to buffer tank 40 through cell pressure controller 38, and from low pressure buffer tank 40, fluorine is provided to compressor 42. Compressor 42 is coupled to low pressure buffer tank 40 and, at its output, to process gas storage tank 44. Compressor 42 compresses the fluorine gas to, for example, about 15 psi in process gas storage tank 44. From process gas storage tank 44, process gas can be provided to one or more fabrication tools via process gas feed line 46. Process gas feed line 46 can be at positive pressure.

Output filter 36 can be a monel filter or other suitable filter as known to those in the art. Compressor 42 can be a non-speed controlled compressor. Cell pressure controller 38 can be any cell pressure controller as known to those in the art. Although not shown in FIGS. 1 and 2, process gas generation system 10 can include other commonly used piping components as known to those in the art, such as regulator valves, seal pots, pressure transducers, thermal couples, miscellaneous filters at various points in the gas piping, and a valve control system. The valves can be air-operated valves as known to those in the art.

FIG. 2 is a simplified block diagram of another embodiment of the method and system of this invention for providing on-site generation and distribution of a process gas at or near a fabrication facility. FIG. 2 is in most respects, identical to FIG. 1. The notable exception between the two FIGUREs is that downstream of output filter 36, fluorine gas is provided directly to compressor 50, and from compressor 50 directly to process gas storage tank 44. Compressor 50 can be speed-controlled to maintain pressure at process gas generation cells 14 at a set value, which can be arbitrarily determined for a given application. As in FIG. 1, fluorine gas is provided from process gas storage tank 44 to one or more fabrication tools via process gas feed line 46. The embodiments of FIGS. 1 and 2 can provide process gas to fabrication tools at a positive pressure. Process gas generation system 10 of FIGS. 1 and 2 can also include a power supply, such as a 480 volt, three-phase 50/60 hertz electrical power supply 60, to provide electrical power to the electrical components of process gas generation system 10.

Embodiments of the method and system for on-site generation and distribution of a process gas of the present invention can produce fluorine or another process gas at a set pressure, for example, at a maximum pressure of 8 millibars gauge. Compressors 42 and 50 of FIGS. 1 and 2, respectively, can be configured to maintain the pressure at process gas generation cells 14 at or below the set pressure to assure the flow of process gas from process gas generation cells 14. For example, compressors 42 and 50 can have suction capability of, for example, minus 0.5 bars gauge. In the embodiment of FIG. 1, compressor 42 is located between a low-pressure fluorine buffer tank 40 upstream of its inlet and a high pressure process gas storage tank 44 downstream of its outlet. Cell pressure controller 38 (of FIG. 1) upstream of low-pressure buffer tank 40 can be set to cycle (e.g., vary the pumping rate of) compressor 42 only when the pressure as measured at process gas generation cells 14 is above a setpoint determined to ensure that compressor 42 does not continue to operate when electrolysis (process gas generation) is off. This set point could, for example, be set at minus 100 millibars gauge. Compressor 42 is cycled to maintain vacuum at low pressure buffer tank 40 (and hence at process gas generation cells 14) and to maintain a set pressure at process gas storage tank 44.

Embodiments of the process generation system 10 of the present invention can produce, for example, up to 700 grams per hour of a process gas such as fluorine. Further, process gas storage tank 44 can be, for example, 125 250-liter storage tank maintained at about 15 psig. Hydrogen fluoride conversion efficiency at process gas generation cells 14 is on the order of about 1 kilogram of fluorine to 1.15 kilograms of hydrogen fluoride. Embodiments of the present invention are capable of producing 99.9999 percent pure fluorine with less than 100 parts per billion total metals, and with less than 10 parts per billion sodium, cadmium and potassium impurities.

FIG. 3 is a slightly more detailed block diagram of an embodiment of the system for on-site generation and distribution of a process gas of the present invention. Process gas generation system 100 of FIG. 3 is the equivalent of the process gas generation 10 shown in FIGS. 1 and 2. Process gas generation system 100, however, includes various additional components, as known to those in the art, for the proper operation of a process gas generation system. These components include valves 110, pressure transducers 120, thermocouples 130, level sensors 140, sample cylinders 150, filters 160 and various interconnecting piping and manifolds. FIG. 3 is an exploded diagrammatic view of the simplified process gas generation systems 10 of FIGS. 1 and 2.

Other embodiments of the present invention can comprise a fluorine generator housed in a single enclosure. The enclosure can comprise a cabinet coupled to a vacuum source operable to maintain air flow through the cabinet, for example, at a velocity of 150 to 200 feet per minute at any cabinet opening. The cabinet can thus be maintained at a negative pressure. The vacuum source can be part of a cabinet abatement system having the capacity to treat the accidental release of process gas from any part of the generator or cabinet. The air flow through the cabinet is exhausted to the abatement system, which can be capable of neutralizing any process gas release up to the maximum amount of gas designed to be present at any time in the generator or its cabinet.

Embodiments of this invention can comprise a cabinet having an integrally housed abatement system to handle the accidental release of a process gas. For example, one embodiment can comprise a fluorine abatement system (FAS) placed in line with the main house exhaust of a fabrication facility. The effluent gas stream from the fluorine generator cabinet can be configured to always run through the fluorine abatement system and then to the house exhaust system for further treatment. An alternative embodiment can comprise an exhaust configuration such that the FAS can be inactive during normal operation and placed online (activated) only when an accidental release of a process gas has occurred inside of the cabinet. This can be accomplished using an electronic valve triggered by a process gas (e.g., fluorine) sensor to direct cabinet exhaust through alternate paths of a dual-exhaust system. Such a process gas sensor is well known in the art and commonly available.

A dual-exhaust FAS cabinet embodiment is preferred because of back pressure and moisture concerns that arise when running an air stream constantly through a fluorine abatement system. This is because moisture in the air flowing through the absorbent materials in a FAS can degrade the absorbent material regardless of whether or not a process gas, such as fluorine, is present in the exhaust air passing through the material. Therefore, it is desirable to have the least possible amount of air flow through the FAS.

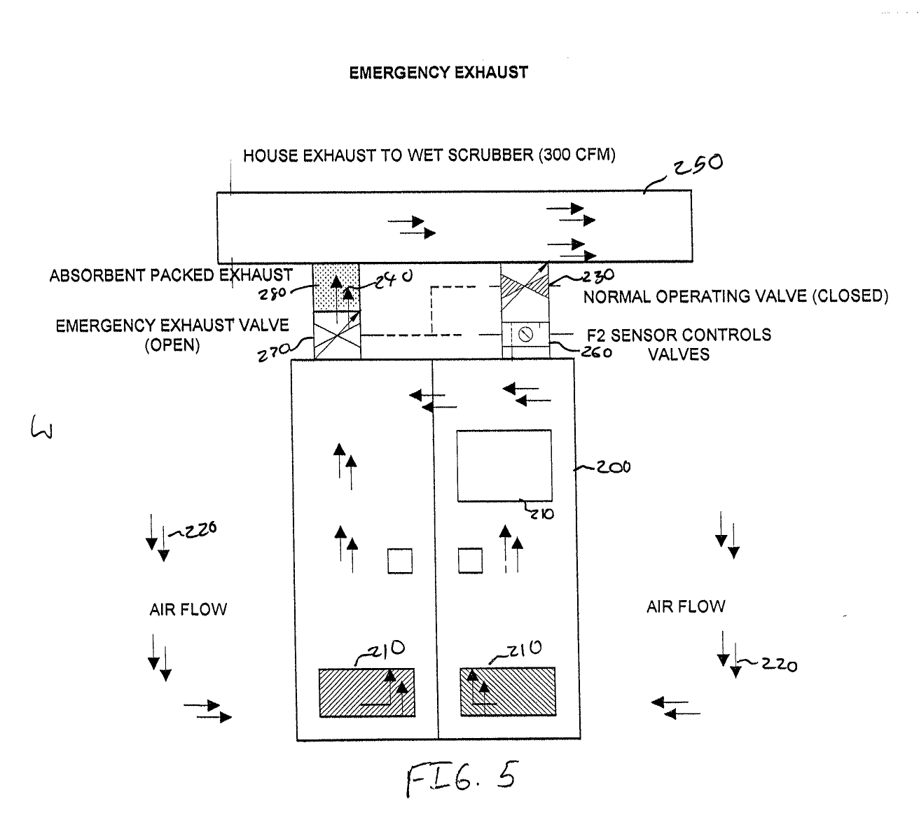

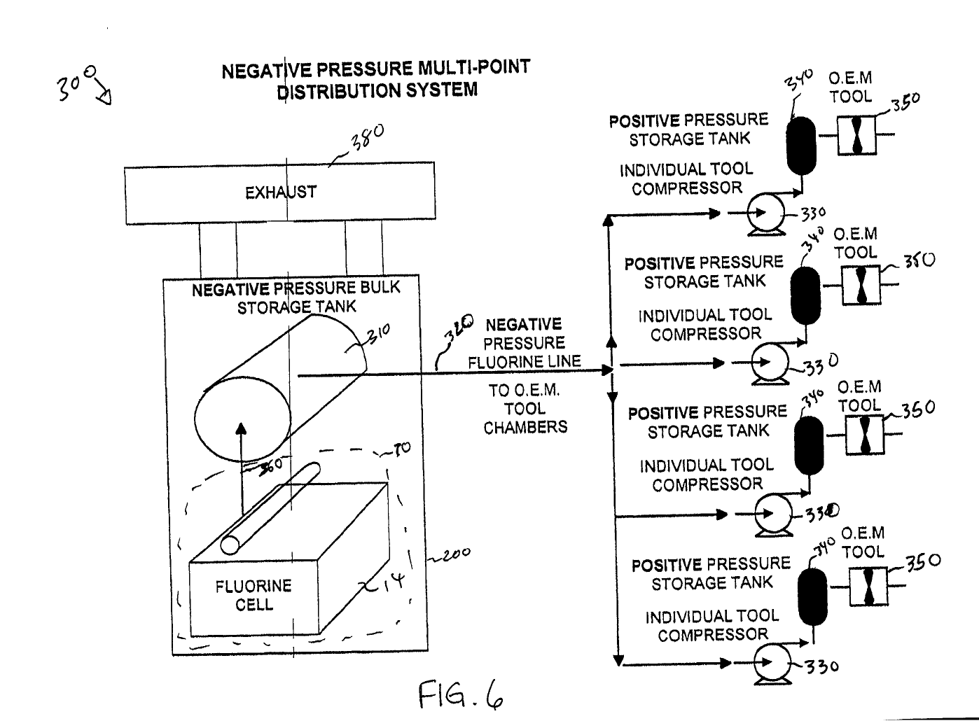

FIGS. 4 and 5 illustrate one embodiment of a process gas generator cabinet 200 of this invention incorporating a dual exhaust system. Cabinet 200 or FIG. 4 houses a fluorine generator, such as described in the embodiments of FIGS. 1, 2 and 3. The cabinet 200 can include vents 210 for receiving intake airflow 220, which circulates through the interior of cabinet 200 and is output through, in normal operation, normal operating valve 230. After passing through normal operating valve 230, exhaust 240 is forwarded through connecting piping coupled to cabinet 200 to house exhaust system 250. House exhaust system 250 can carry cabinet exhaust 240, as well as various other fabrication facility exhausts, to the outside atmosphere. House exhaust system 250 can pass through various other filtering components before venting to the outside atmosphere. House exhaust system 250 can correspond to, for example, service ventilation system 26 of FIGS. 1 and 2.

The embodiments of the method and system for on-site generation and distribution of a process gas of the present invention contemplate that there will be no purposeful venting of large amounts of a process gas to the atmosphere. As shown in FIGS. 4 and 5, there is no purposeful venting of process gas (fluorine) into either cabinet 200 or into the room housing cabinet 200. For example, when switching from one sodium fluoride trap 32 to another sodium fluoride trap 32, vacuum is pulled on the regenerating sodium fluoride trap 32 and minute amounts of fluorine from the hydrogen fluoride inside NaF traps 32 can be brought into exhaust 240. It is contemplated that the amounts of fluorine and hydrogen fluoride brought into house exhaust 250 by exhaust 240 during such a regeneration event can be adequately handled by the house exhaust system 250 abatement system. Unlike the prior art, embodiments of the present invention do not require large and complex external absorbers because large amounts of process gas are not dumped into either the room containing cabinet 200 or into house exhaust system 250. Under normal operating conditions, there is no substantial amount of fluorine in the atmosphere outside or inside of cabinet 200 housing process gas generation system 10.

Fluorine sensor 260 can be used to control normal operating valve 230 and emergency exhaust valve 270 to determine the path of the air flow of cabinet 200. During normal operation, exhaust 240 passes through normal operating valve 230 before being forwarded to house exhaust system 250. If, however, fluorine sensor 260 detects fluorine above a preset level in the cabinet air, fluorine sensor 250 can shut normal operating valve 230 and open emergency exhaust valve 270 to direct exhaust flow 240 through absorbent packed exhaust 280. This configuration is illustrated in FIG. 5, which shows the air flow through cabinet 200 during an emergency breach situation wherein air and fluorine gas are exhausted from cabinet 200. Normal operating valve 230 and emergency exhaust valve 270 can be electronic gate valves, or air-activated valves, as known to those in the art. Process gas generation system 10 within cabinet 200 can further comprise an appropriate valve control system as known in the art.

As shown in FIG. 5, exhaust 240 comprises a fluorine gas and air mixture prior to passing through absorbent packed exhaust 280. After flowing through absorbent packed exhaust 280, however, exhaust 240 comprises air with only trace amounts of fluorine which can then be vented to house exhaust system 250. The absorbent material in absorbent-packed exhaust 280 can be recharged or replaced to restore its effectiveness. The embodiments of the present invention can further be configured such that fluorine sensor 260 is operable to shut down process gas generation system 10 if it detects fluorine in the interior of cabinet 200. Beyond shutting down process gas generating system 10, fluorine sensor 260 can also redirect exhaust 240, as previously described. The source of the process gas leak can then be identified and repaired. A fabrication facility employing an embodiment of this invention can thus be relieved of the need for an external exhaust system and its associated external abatement system because the abatement system of cabinet 200 is capable of containing any potential fluorine gas leak from process gas generation system 10 within cabinet 200. Embodiments of this invention can thus provide the advantage of an in-situ emergency absorbent exhaust system that can eliminate the need for a dedicated external exhaust abatement system. FIG. 5 is otherwise identical to FIG. 4 and is intended to illustrate the different flow path of exhaust 240 through absorbent packed exhaust 280, as opposed to through normal operating valve 230.

Fluorine sensor 260 can be set to detect a threshold limit of fluorine, at which point it will switch from normal exhaust mode to emergency exhaust mode as described above. For example, the threshold can be set at three parts per million, or other arbitrarily determined limit as required by a given application. When the threshold fluorine limit is exceeded, fluorine sensor 260 can cause normal operating valve 230 to close and can cause emergency exhaust valve 270 to open, thus redirecting the flow of exhaust 240 through absorbent packed exhaust 280, which can contain enough absorbent material (e.g., aluminum oxide) to neutralize any fluorine present inside of cabinet 200 (i.e., released from process gas generation system 10), plus a preset safety factor (e.g., two times the total fluorine in process gas generation system 10).

The dual exhaust aspect of the embodiments of this invention can thus provide the advantage over a prior art system that exhaust 240 can be directed through an abatement system's absorbent material only if there is excessive fluorine (or other process gas) present in the air flow. Because exhaust 240 is not passed continually through the absorbent material, the absorbent material will have a much longer useful life than in prior art systems. The absorbent packed exhaust 280 can, therefore, be maintained in an activated state for a time when it is actually needed. Fluorine sensor 260, emergency exhaust valve 270, normal operating valve 230 and absorbent packed exhaust 280, together operate to direct exhaust 240 through the absorbent material only in the event of a fluorine release. Because fluorine sensor 260 is in line with the flow of exhaust 240 under normal operating conditions, it is in a position to detect excessive fluorine concentrations at all times. Once the fluorine is removed by absorbent packed exhaust 280, clean air is exhausted to house exhaust 250, thereby preventing the dumping of a process gas into house exhaust 250 and eliminating the need for a complex and expensive house abatement system. The embodiments of this invention can avoid the cost and space demands of traditional abatement systems and still conform to safety and fire codes required of fabrication facilities.

FIG. 6 is a simplified, diagrammatic representation of a process gas bulk distribution embodiment of the method and system of this invention. Negative pressure multipoint distribution system 300 can comprise a negative pressure bulk storage tank 310, which can be of a size much smaller than that of prior art systems. Negative pressure bulk storage tank 310 can store and then supply a process gas through a negative pressure process gas line 320 to individual tool compressors 330. Individual tool compressors 330 can each supply, under positive pressure, the process gas to one or more fabrication tools 350.

Negative pressure multi-point distribution system 300 can also comprise one or more process gas generation cells 14 for generating and then supplying, as described with respect to FIGS. 1, 2 and 3, purified fluorine gas to negative pressure bulk storage tank 310 through feed line 360. Although greatly simplified, the portion of multi-point distribution system 300 within the dotted lines can be, for example, cabinet 200 of FIGS. 4 and 5, containing process gas generation system 10 of FIGS. 1, 2 and 3. Although all the connections, pumps, filters and manifolds of process gas generation system 10 are not shown, the same system can be used to provide a process gas to negative pressure bulk storage tank 310 via a feed line 360.

Multi-point distribution system 300 of FIG. 6 is analogous to process gas generation system 10 of the previous FIG. 5. The embodiment of FIG. 6 is a scaled up version with the negative pressure piping portion (e.g., the section between cell pressure controller 34 and compressor 42 of FIG. 1) stretched out such that a much longer negative-pressure piping run can be incorporated. The positive pressure lines from the outlet of compressor 42 to the fabrication tool, as shown in FIG. 1, are conversely shortened such that in the embodiment of FIG. 6, the positive pressure lines are essentially local to the fabrication tool. This configuration can greatly increase safety over the prior art because long runs of positive pressure fluorine gas delivery piping can be eliminated. The negative pressure multi-point distribution system 300 can also comprise an exhaust system 380, which can contain an abatement system as described in accordance with the teachings of this invention.

The negative pressure multi-point distribution system 300 of the embodiments of this invention can provide for bulk distribution of a process gas to multiple tools without the need for a very large process gas storage tank as required by the prior art. This is because a gas under vacuum can be delivered much easier and faster than by a positive pressure process. Negative pressure process gas lines 320 can thus be significantly smaller lines. The prior art requirement of having to store many cylinders (or one large cylinder) to provide bulk process gas can also be eliminated, as can the corresponding abatement systems necessary to neutralize the large amounts of gas stored on site.

Instead, embodiments of the bulk distribution aspect of the method and system for on-site generation and distribution of a process gas of this invention can use individual tool compressors 330 and positive pressure storage tanks 340 for each fabrication tool 350. Together they can provide the ability to deliver a process gas to a fabrication tool 350 in a much safer manner, under vacuum, rather than under a positive pressure. The need for a large process gas storage tank is thus eliminated and the emergency treatment requirements in case of an accidental release of a process gas are greatly simplified. Positive pressure storage tanks can be, for example, 10 liter storage tanks. Compressors 330 can be metal bellows, 40 psig output pressure compressors as known in the art.

As shown in FIG. 6, process gas generation system 10 can be housed in a cabinet 200 with its own exhaust system 380. Inside of the cabinet is located a relatively small negative pressure bulk storage tank 310. For example, negative pressure bulk storage tank 310 can be a 200 liter storage tank. Unlike prior art systems that require a very large storage tank that provides process gas at a positive pressure, the embodiments of the bulk distribution aspect of this invention can instead provide an individual tool compressor 330 feeding a positive pressure storage tank 340, which can in turn provide process gas at a positive pressure to a fabrication tool 350. Each fabrication tool 350 can thus have an associated compressor and small storage tank that can provide the fabrication tool 350 with enough process gas to run at peak (e.g., approximately 20 liters). Positive pressure storage tanks 340 can be sized as required for a given application (e.g., 10 liters).

Bulk distribution embodiments of this invention (e.g., as shown in FIG. 6) can comprise one or more large fluorine generators feeding multiple fabrication tools. Cabinet 200 can house a process gas generation system 10, as described with respect to FIGS. 1-5. Process gas generation system 10 provides process gas to negative pressure bulk storage tank 310, which, in turn, provides process gas to process gas delivery lines 320, that are coupled to individual tool compressors 330. Further, negative pressure multi-point distribution system 300 can comprise an exhaust system 380 which can comprise an abatement system sufficient to abate all of the fluorine housed within cabinet 200.

Negative pressure process gas distribution lines 320 are coupled to negative pressure bulk storage tank 310 and to each individual tool compressor 330 to deliver process gas. An advantage of the bulk distribution embodiments of this invention is that negative pressure bulk storage tank 310 can provide process gas through process gas distribution lines 320 at a negative pressure, while still providing process gas at a positive pressure to each fabrication tool 350. Each individual tool compressor 330 pulls a vacuum on process gas distribution lines 320, which are coupled to negative pressure bulk storage tank 310. A vacuum is thus pulled on negative pressure bulk storage tank 310. At the same time that individual tool compressors 330 are pulling a vacuum at their inlet, they are pumping process gas at a positive pressure at their outlet (i.e., to a positive pressure storage tank 340). Process gas can then be provided at a positive pressure from positive pressure storage tanks 340 to each fabrication tool 350.

Process gas generation system 10 inside of cabinet 200 is generating process gas and providing it to negative pressure bulk storage tank 310. Because individual tool compressors 330 create a vacuum at negative pressure bulk storage tank 310, process gas generation system 10 is generating process gas at a vacuum at a fluorine cell 14. Process gas generation system 10 can produce a process gas at a rate required to meet the demand from each individual tool compressor 330. If negative pressure bulk storage tank 310 should reach a positive pressure, this is an indication that individual tool compressors 330 are not demanding process gas at least at the rate of process gas generation. Process gas generation system 10 is operable to shut itself down once a preset pressure (e.g., a positive pressure) is detected at negative pressure bulk storage tank 310. This can be accomplished, for example, by use of a pressure transducer communicatively connected to and operable to shut down process gas generation system 10.

Referring now to FIGS. 1, 2 and 3, in contrast to negative pressure multipoint distribution system 300 of FIG. 6, and to further explain the operation of the embodiment of FIG. 6, in FIG. 1, process gas generation system 10 comprises a positive pressure delivery system through output line 46. At the outlet to low pressure storage tank 40, compressor 42 is pulling a vacuum on low pressure storage tank 40. Process gas generation cells 14 of process gas generation system 10 generate the process gas at a low pressure (e.g., 1 psi (8 millibars)). Cell pressure controller 38 can measure the pressure at process gas generation cells 14, and cycle the process gas generation cells on and off (via, for example, a programmable logic controller control system, as known in the art) to control the flow of fluorine gas to low pressure buffer tank 40 by opening and closing the inlet valves to NaF traps 32. Compressor 42 thus maintains low pressure storage tank 40 at a vacuum.

Compressor 42 can be a continuous cycle compressor, and thus, in operation, can maintain a vacuum at low pressure storage tank 40 while also maintaining a positive pressure (e.g., 15 psig) at process gas storage tank 44. As process gas is generated by process gas generation cells 14, it is provided to low-pressure buffer tank 40, where it will increase pressure if there is no demand for the process gas. If the pressure at low-pressure buffer tank 40 reaches a preset level (e.g., 1 psi), cell pressure controller 38 is operable to provide a signal to process gas generation system 10 and shut down the gas generation process. This is because a pressure increase inside of low-pressure buffer tank 40 is an indication that process gas demand is lower than the process gas generation rate. Process gas generation system 10 is shut down because as pressure increases inside gas generation cells 14, electrolyte can be pushed out with the fluorine gas and react violently outside of the process gas generation cell 14. When process gas demand increases, the pressure inside process gas storage tank 44 decreases, causing flow into process gas storage tank 44 from low pressure buffer tank 40. Low pressure buffer tank 40 drops in pressure (vacuum increases), and cell pressure controller 38 will detect the vacuum increase and cycle process gas generation system 10 back on and open the inlet valves to NaF traps 32. This process can repeat itself continuously in normal operation.

The operation of negative pressure multi-point distribution system 300 of FIG. 6 of process gas generation system 10 is thus analogous to the operation. Negative pressure bulk storage tank 310 of FIG. 6 can correspond to low-pressure buffer tank 40 of FIGS. 1, 2 and 3, but on a larger scale. Each of the individual tool compressors 330, which can correspond to internal compressor 42 of FIGS. 1, 2 and 3, is taking a vacuum on negative pressure bulk storage tank 310. As a result, a vacuum is maintained inside of negative pressure bulk storage tank 310, which is being fed process gas by process gas generation system 10. Should negative pressure bulk storage tank 310 reach a preset pressure (e.g. a positive pressure), as described above, process gas generation can be cycled off. Gas generation is cycled off to match demand and to protect process gas generation cells 14 because, as discussed above, a pressure increase in negative pressure bulk storage tank 310 indicates that process gas demand is less than the process gas supply rate. Once fabrication tools 350 start demanding process gas, a vacuum will once again be pulled inside of negative pressure bulk storage tank 310 by individual compressors 330. As the pressure decreases in bulk storage tank 310 (e.g., the vacuum increases), a control signal can be generated by a control system to cycle process gas generation system 10 back on and restart generation of process gas. This can be accomplished, for example, by a pressure transducer communicatively coupled to both negative pressure bulk storage tank 310 and to the control system for process gas generation system 10.

Individual tool compressors 330 can each provide a positive pressure at their outlet to a positive pressure storage tank 340. Operation of process gas generation system 10 within cabinet 200 is controlled by the increase/decrease of pressure inside of negative pressure bulk storage tank 310. Positive pressure storage tanks 340 can be sized to provide the necessary supply of process gas for a given operation to a fabrication tool 350.

The negative pressure multi-point distribution system embodiments of the method and system of this invention for on-site generation and distribution of a process gas can provide an advantage of minimizing the size of the process gas storage tank. Unlike prior art systems, a large process gas storage tank is not required, and therefore the corresponding complex and expensive abatement system necessary to ensure that the entire contents of such a tank can be neutralized are also not required. A further advantage is that all overhead process gas distribution lines 320 can be under vacuum (i.e., at a negative pressure). If a line should break, fluorine (or other process gas) and atmospheric gases will be sucked back into negative pressure bulk storage tank 310 instead of being expelled out into a fabrication facility. A minimal amount of a process gas is thus exposed to the atmosphere of a fabrication facility, such that the in-house abatement systems can handle such a release.

Each individual fabrication tool 350 can have its own cabinet with its own abatement system that can direct exhaust to an in-house scrubber. For example, a dual-exhaust system within a cabinet 200, as previously described with regards to FIGS. 4 and 5, can be provided at each fabrication tool 350. Individual abatement systems for each fabrication tool 350 and its related tool compressor 330 and storage tank 340 can thus be provided to neutralize the process gas stored within each positive pressure storage tank 340. The overhead process gas distribution lines 320, because they are at a negative pressure, avoid the possibility that a process gas release into a fabrication facility will occur from negative pressure bulk storage tank 310. Individual tool-specific positive pressure storage tanks 340 eliminate the pressurized source supply line requirements of prior art systems and their corresponding, expensive abatement systems.

Process gas generation system 10 of the embodiments of this invention can be sized based on the needs of a particular application. For example, one embodiment of the process gas generation system 10 of this invention can be sized to produce 700 grams of process gas per hour. The process gas generation cells 14 can be, for example, 10-blade cells, 30-blade cells, or 150-blade cells, depending on the application. The embodiments of this invention are directed to minimizing the amount of process gas storage on-site and further to delivering a process gas, such as fluorine, on demand. Thus, the embodiments of the process gas generation system of this invention can deliver, for example, from 0 to 700 grams of a process gas per hour. This means that they can generate process gas in amounts anywhere up to their maximum capacity, depending on the demand. Demand, in turn, can be measured by the pressure within the supply lines and within the storage tanks of the process gas generation system 10.

By providing a positive pressure storage tank 340 and an individual tool compressor 330 for each fabrication tool 350, the embodiments of the bulk distribution aspect of this invention can provide the ability to deliver process gas on demand and, for the majority of a process gas piping run, under negative pressure, while still providing the process gas at a positive pressure to each fabrication tool 350. Positive pressure process gas is delivered from a tool-specific positive pressure storage tank 340 to a fabrication tool 350 while being delivered to the vicinity of positive pressure storage tank 340 at a negative pressure (i.e., to individual tool compressors 330). The dual purposes of delivering positive pressure process gas to a fabrication tool 350, while maintaining negative pressure in process gas delivery lines 320 for safety reasons, can thus be met by the embodiments of this invention.

It is contemplated that a positive pressure storage tank 340 and an individual tool compressor 330 can be housed within a single unit attached directly to a fabrication tool 350. Further, each such unit could have its own individual abatement system, as previously discussed. A unit comprising a compressor, a mini storage tank, and a fabrication tool are contemplated to be within the scope of the present invention.

It is an aspect of other embodiments of the method and system for on-site generation and distribution of a process gas of the present invention to provide for a mobile and compact containment vessel for hazardous liquids associated with process gas generation. Hazardous liquids require secondary containment, transportation, and storage. The process gas generators 14 of the embodiments of this invention can contain an electrolyte in a liquid stage during normal operation that will require secondary containment. Secondary containment systems of the prior art are large and unwieldy and require heavy equipment, typically a forklift or other such device, to move them. The embodiments of this invention contemplate a liquid-tight, sealed outer container (for example, welded stainless steel) around each process gas generation cell 14. The outer sealed container can act as both a secondary containment system and as a shipping crate for each process gas generation cell 14. This configuration can eliminate the need for a dike, such as that used in prior art methods and systems, and avoid the manufacturing problems associated with such liquid-tight enclosures. The secondary containment system contemplated by the embodiments of this invention can be equipped with casters or other such rolling hardware to eliminate the need for the additional working space required for a forklift or other heavy machinery to install or remove process gas generation cells 14.

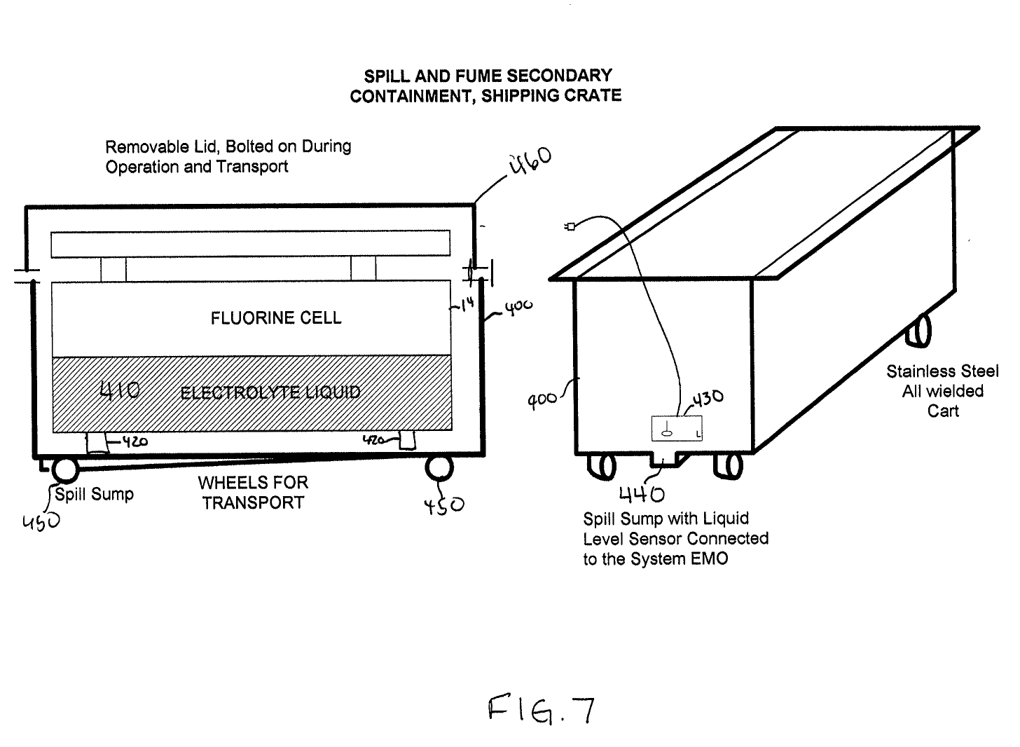

FIG. 7 shows a containment cart 400 housing a process gas generation cell 14 containing electrolyte liquid 410. Containment cart 400 is sized to contain all of the electrolyte liquid 410 inside of a process gas generation cell 14 in the event of a leak or other rupture. With reference to FIG. 1, hydrogen fluoride is provided as an input to the electrolyte liquid 410 to generate, in this case, fluorine gas, which is output along with trace amounts of hydrogen fluoride and waste metals from process gas generation cell 14. In the embodiment shown in FIG. 7, containment cart 400 surrounds process gas generation cell 14 of process gas generation system 10. A process gas generation cell 14 can be, for example, three feet to four feet tall, 20 inches wide, and five feet long, and made out of half-inch thick monel or nickel. A typical process gas generation cell 14 can weigh on the order of 1,000 pounds. In prior art methods, the entire process gas generation system is first built and then a dike is constructed around the process gas generation system of sufficient height to contain any and all electrolyte liquid that might be spilled. The dike containment is intended to contain the electrolyte liquid until it can be easily cleaned up. As a safety requirement, a containment system must typically be able to capture 110% of the amount of hazardous liquid contained in the process gas generation system.

Referring to FIG. 7, if a breach occurs in process gas generation cell 14, resulting in a release of electrolyte liquid 410 into containment cart 400, containment cart 400 is of sufficient capacity to fully contain all of the electrolyte liquid 410. Although containment cart 400 is shown as a rectangle, various other shapes are contemplated to be within the scope of this invention. Containment cart 400 can be made of a material that is inert to the electrolyte within process gas generation cell 14, such as stainless steel, nickel, or other suitable material.

Containment cart 400 of FIG. 7 also comprises rolling hardware 450, which can be coasters, wheels, or other such mechanisms as known in the art, to provide a means of transporting containment cart 400 by a rolling motion. Unlike prior art methods requiring the building of an expensive dike, and the consequent requirement of having to get over that dike with a heavy piece of equipment, such as process gas generation cell 14, containment cart 400 of the embodiments of this invention does not require either a forklift or a dike to be built around process gas generation system 10. Containment cart 400 can, because the need for a dike lip is eliminated, be rolled directly into a cabinet 200 containing process gas generation system 10. Further, containment cart 400 can be sized to capture 110% of the electrolyte liquid within process gas generation cell 14.

Containment cart 400 can also function as a shipping crate. Containment cart 400, for example, can be manufactured by welding together five pieces of metal to form a five-sided rectangle and then covered with a removable lid 460. The bottom of containment cart 400 should be constructed to withstand the weight of process gas generation cell 14. Containment cart 14 can comprise a level sensor 430 for detecting the presence of an electrolyte liquid within containment cart 400 to indicate that a leak has occurred within process gas generation cell 14. Level sensor 430 can be located within a sump 440, shaped to channel spilled electrolyte to level sensor 430. Supports 420 can be included to support process gas generation cell 14 within containment cart 400.

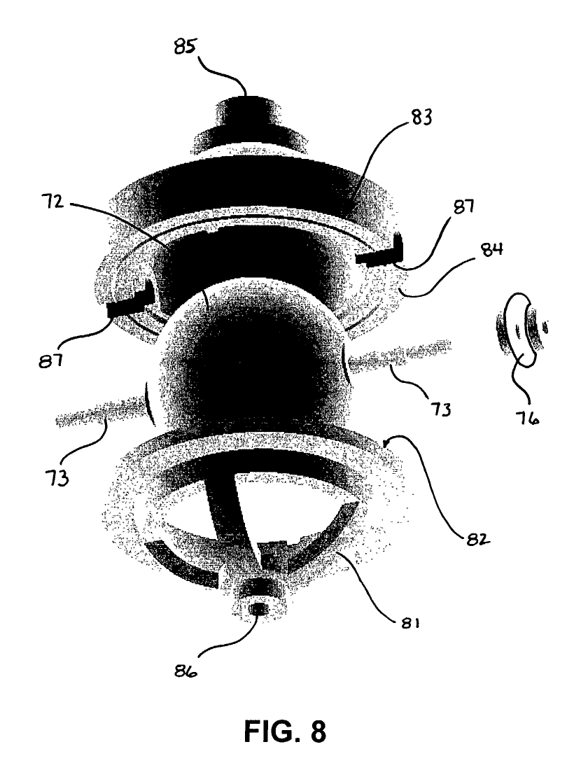

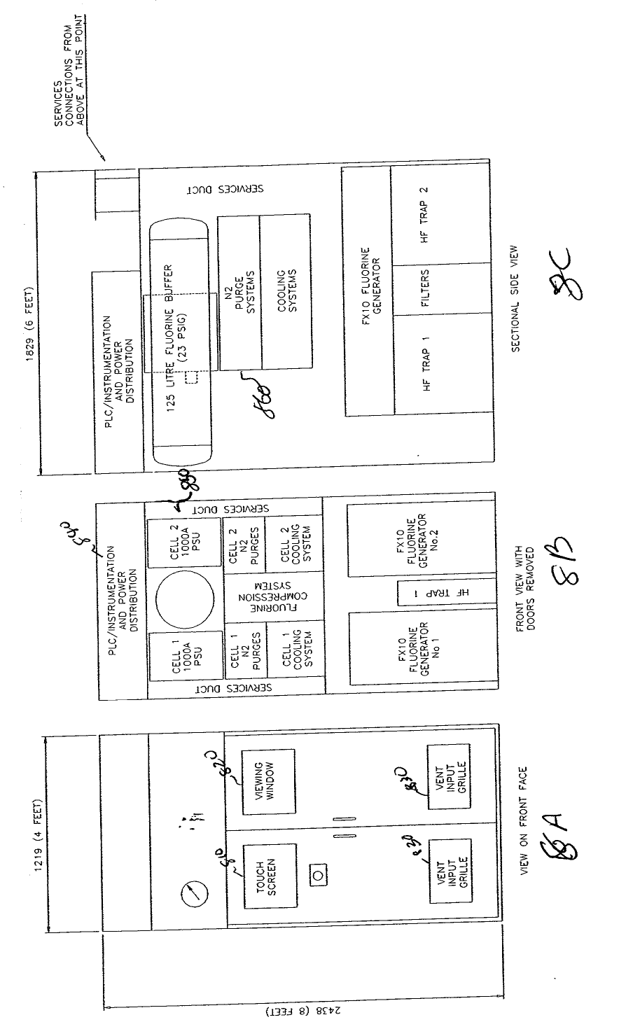

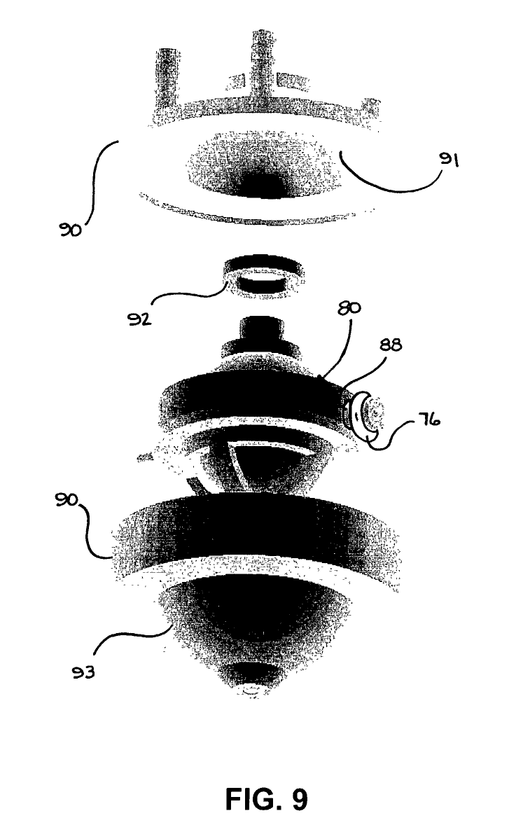

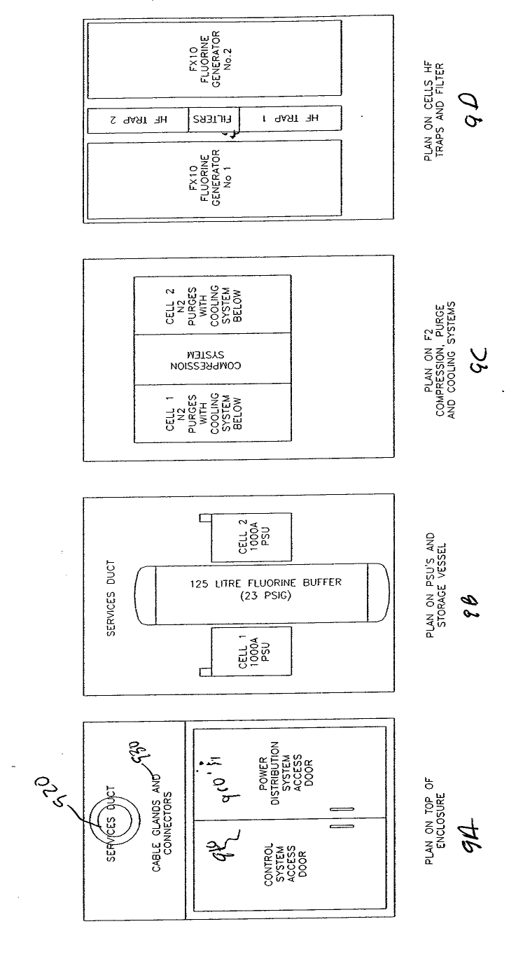

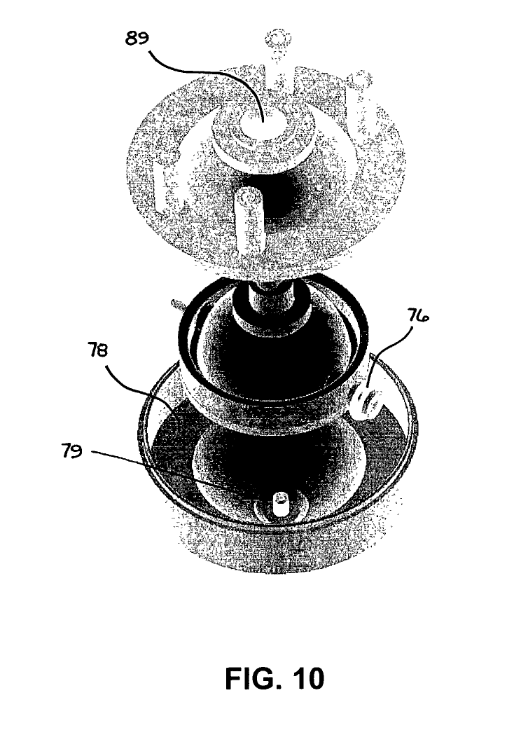

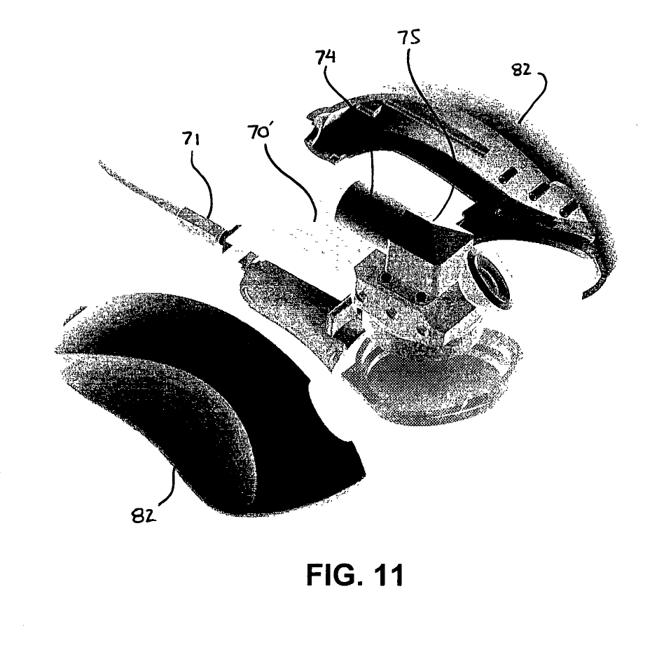

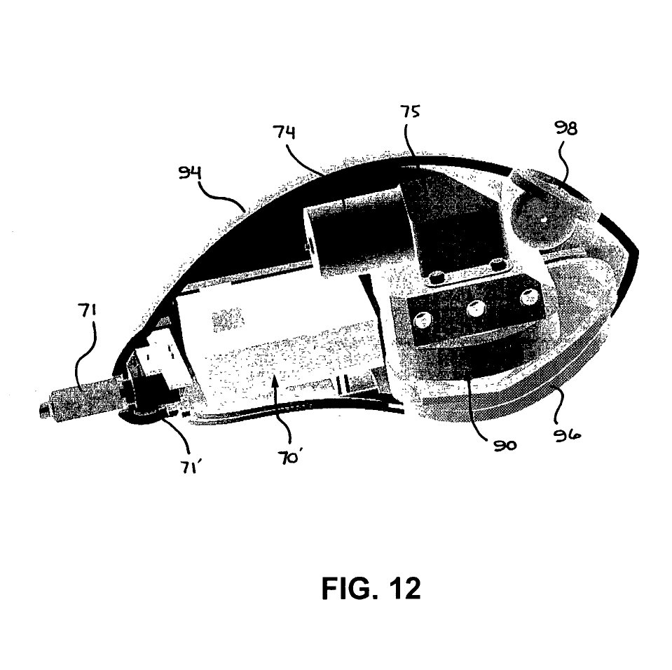

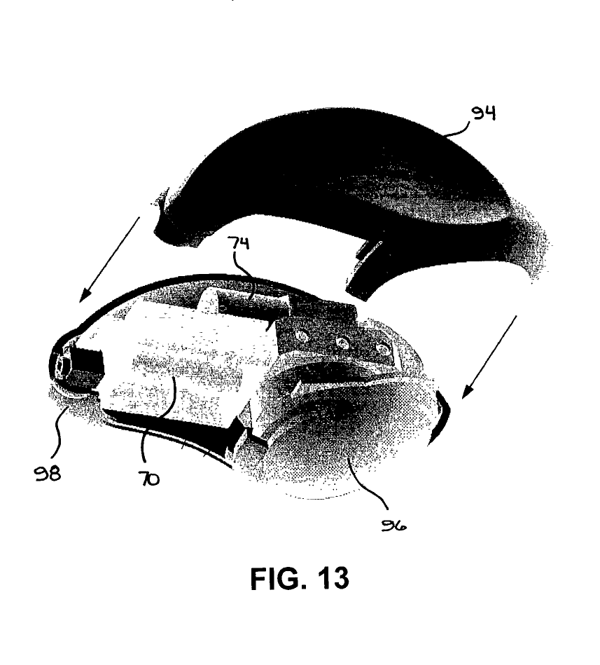

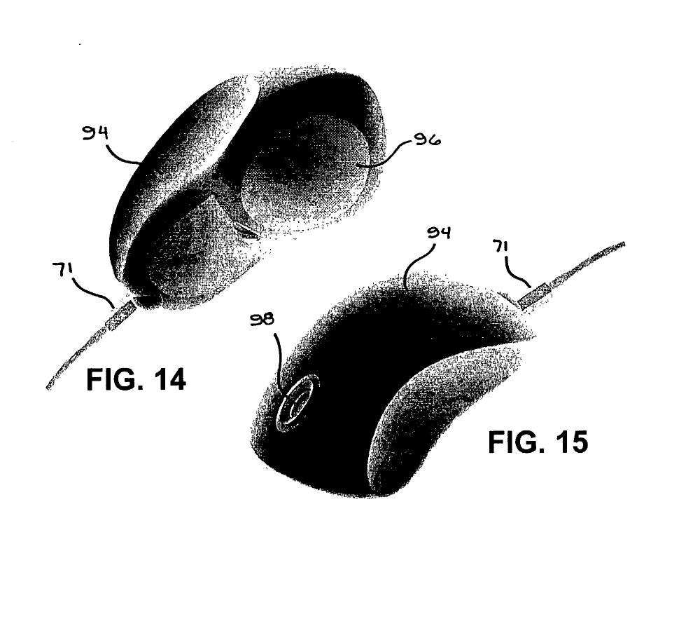

FIGS. 8A-8C and FIGS. 9A-9D show side and top view perspectives of one embodiment of cabinet 200 of this invention. FIG. 8A shows a view and front face elevation of cabinet 200, including touchscreen 810, viewing window 820, and vent input grills 830. Touchscreen 810 can be an interface, such as a graphical user interface, for the control systems of process gas generation system 10, which will be described in greater detail below. FIG. 8B shows a front view of the interior of cabinet 10 with the doors removed. PLC instrumentation and power distribution system 840 is shown at the top of FIG. 8B. Other components of process gas generation system 10, as described with respect to previous FIGURES, are also shown within FIG. 8B and numbered accordingly. Services duct 850 provides access to the interior of cabinet 200. FIG. 8C shows a sectional side view of cabinet 200, including various components of process gas generation system 10 previously described, as well as nitrogen purge system 860, which can be used when replacing sodium fluoride traps 32.

FIGS. 9A, 9B, 9C and 9D show further cross section and elevation views of cabinet 200 and corresponding interior components of process gas generation system 10. FIG. 9A is a plan view from the top of cabinet 200 showing control system and access doors 910 and services duct 920, as well as cable glands and connectors 930. FIG. 9B shows a plan on top of cabinet 200 with the top of the enclosure of cabinet 200 removed to show the interior of cabinet 200. Similarly, FIG. 9C shows a plan on the process gas compression, purge, and cooling systems, and FIG. 9D shows a plan on the process gas generation cells 14, filters 35, and sodium fluoride traps 32.

The embodiments of the present invention can further comprise a control system to provide for the supervised control, status monitoring, fault handling, and alarm enunciation of various process gas generation system equipment items can be monitored by such a control system. For example, the status of process gas generation cells 14, sodium fluoride traps 32, compressors 42 and 45, cooling systems 18, and other ancillary equipment items. The main control system can be implemented utilizing a single industrial programmable logic controller (PLC), with a recessed touch screen graphical monitor providing the primary operator interface. The primary operator interface can be touch screen 810 of FIG. 8A. Other subsystems that also provide control and monitoring functions can be interfaced to the main control system to provide status indication of key control parameters. The control system physical design can be based on a modular system allowing quick change-out of key components for maintenance and breakdown purposes, ensuring the mean time to repair is kept to a minimum. The main control system can be housed on a single control platform located at, for example, the top of a space envelope defined for cabinet 200.

A safety interlock system, as known to those in the art, can also be built into the embodiments of the on-site generation and distribution of process gas method and system of this invention. For example, abnormal and emergency conditions that warrant a more reliable, higher integrity response of the control system than that afforded by a programmable system such as a PLC control system can be designed and implemented with the embodiments of this invention. The design and implementation of such control systems is well known in the art. System architecture and components can be designed to allow for interconnection of external systems and for future development of control strategies for a process gas generation system 10 in accordance with the teachings of this invention. A single programmable logic controller can be used to provide the instrumentation interface for the gas generation process via discrete digital and analog input and output modules housed in a multi-slot frame, to include a PLC processor module and power supply modules.

The main control system operator interface 810 can be implemented using a single touch screen monitor mounted in a recess on the front face of cabinet 200. The interface can provide a clear visual representation of the process plant utilizing simplified flow diagrams and tables to depict process streams to aid the operator. Logging onto the system (for example, via a password) can present the operator with a home page detailing the main system equipment process/items, system status, alarm banner and main function keys. A standard border/backdrop can be provided on each screen to provide connectivity between system configured pages that will be navigable via menus or hot function keys. Appropriate system change-out and maintenance flags/prompts can be generated to alert impending service requirements in order to maximize process gas generation system availability. The present invention can also comprise software comprising computer executable instructions for managing process control and instrumentation and display systems.

The embodiments of the method and system for on-site generation and distribution of a process gas of the present invention can provide various advantages over the prior art, including: (1) redundant process gas generation cells and contaminant traps (e.g., NaF traps 32) such that one trap can be operating while another is regenerating; (2) the ability to pull a vacuum to regenerate a contaminant trap and thus avoid purging the containment trap with nitrogen and introducing contaminants into the process gas; (3) the ability to be housed in a compact generator cabinet having a dual exhaust system that can be used to avoid continuous airflow through an absorbent material and thus avoid premature degradation of the absorbent material; (4) the ability to provide an on-demand supply of a process gas under negative pressure; (5) providing individual compressors and storage tanks for each fabrication tool, such that a process gas under negative pressure in a supply line can still be provided at a positive pressure to the fabrication tool; and (6) providing a mobile, compact and self-contained containment system for hazardous liquids associated with a process gas generation cell so that the large and expensive secondary containment systems of the prior art can be eliminated.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

What is claimed is:

1. A system for continuous purification of a gas flow comprising:
a first sodium fluorine trap coupled to a gas supply line, wherein said gas supply line conducts said gas flow;
a second sodium fluorine trap coupled to said gas supply line in parallel to said first sodium fluorine trap;
a switching mechanism operable to switch gas flow from said first sodium fluorine trap to said second sodium fluorine trap at the occurrence of a predefined event.

2. The system of claim 1, wherein said gas flow comprises:
fluorine; and
trace hydrogen fluorine.

3. The system of claim 1, wherein said switching mechanism is operable to switch gas flow from said first sodium fluorine trap to said second sodium fluorine trap when said first sodium fluorine trap is approximately saturated.

4. The system of claim 3, further comprising:
a first manifold operable to direct said gas flow from said gas supply line to said first sodium fluorine trap; and
a second manifold operable to direct said gas flow from said gas supply line to said second sodium fluorine trap.

5. The system of claim 1, further comprising one or more fluorine generation cells, wherein said one or more fluorine generation cells are coupled to said gas supply line and wherein said one or more fluorine generation cells provide said gas flow.

6. The system of claim 1, further comprising:
a gas output line coupled to said first sodium fluorine trap and said second sodium fluorine trap; and
an output filter coupled to said gas output line.

7. The system of claim 6, further comprising:
a low pressure buffer tank in fluid communication with said first sodium fluorine trap and said second sodium fluorine trap, wherein said low pressure buffer tank is located downstream of said output filter; and
a compressor in fluid communication with and downstream of said low pressure buffer tank, wherein said compressor is operable to compress gas from said low pressure buffer tank.

8. The system of claim 1, further comprising:
a low pressure buffer tank in fluid communication with said first sodium fluorine trap and said second sodium fluorine trap; and
a compressor in fluid communication with and downstream of said low pressure buffer tank, wherein said compressor is operable to compress gas from said low pressure buffer tank.

9. A method for purifying fluorine gas comprising:
directing a fluorine gas flow to a first sodium fluorine trap;
determining if said first sodium fluorine trap is approximately saturated; and
if said fluorine trap is determined to be approximately saturated:
switching said fluorine gas flow to a standby sodium fluorine trap;
regenerating said first sodium fluorine trap; and
replacing said first sodium fluorine trap.

10 The method of claim 9, further comprising placing said first sodium fluorine trap in standby mode relative to said standby fluorine trap.

11 The method of claim 9, wherein the step of regenerating said first sodium fluorine trap comprises:
heating said first sodium fluorine trap; and
purging said first sodium fluorine trap with nitrogen.

12. A process gas generation cabinet comprising:
a cabinet housing encompassing a process gas generator, said housing further comprising:
one or more input vents to direct air to said process gas generator; and
a normal output port; and
an emergency output port; and
an exhaust system comprising:
an exhaust channel;
a normal operating channel coupled to said normal output port and said exhaust channel, said normal operating channel further comprising a normal operating valve;
an emergency channel coupled to said emergency output port of said cabinet housing and said exhaust channel, said emergency channel further comprising:
an emergency exhaust valve; and
an absorbent packed material; and
a fluorine sensor located upstream from said normal operating valve; said fluorine sensor operable to close said normal operating valve and open said emergency exhaust valve if fluorine levels in said cabinet housing exceed a preset level.

13. The process gas generator cabinet of claim 12, wherein said exhaust channel comprises a house exhaust system.

14. The process gas generator cabinet of claim 12, wherein said fluorine sensor is operable to shut down said process gas generator if fluorine levels in said cabinet housing exceed said preset level.

15. The process gas generator cabinet of claim 12, wherein said absorbent packed material comprises aluminum oxide.

16. The process gas generator cabinet of claim 12, wherein said fluorine gas sensor is located inline with said normal operating valve.

17. The process gas generator cabinet of claim 12, wherein said cabinet housing further encompasses a negative pressure storage tank operable to store process gas produced by said process gas generator.

18. A gas distribution system comprising:
a process gas generator;
a gas routing mechanism connected to said process gas generation system;
a negative pressure storage tank connected to said gas routing mechanism, said negative pressure storage tank operable to store process gas produced by said process gas generator
a negative pressure line coupled to said negative pressure storage tank;
a compressor coupled to said negative pressure line operable to:
draw process gas from said negative pressure storage tank;
compress said process gas to produce a positive pressure process gas; and
output said positive pressure process gas; and
a positive pressure storage tank in fluid communication with said compressor, said positive pressure storage tank operable to store said positive pressure process gas.

19. The gas distribution system of claim 18, wherein said positive pressure storage tank is further operable to provide positive pressure process gas to a manufacturing tool.

20. The gas distribution system of claim 18, further comprising a cabinet housing encompassing said process gas generator, said gas routing mechanism and said negative pressure storage tank.

21. The gas distribution system of claim 18, wherein said gas routing mechanism comprises a manifold.

22. The gas distribution system of claim 18, further comprising a positive pressure line coupled to said compressor and to said positive pressure storage tank.

23. A gas distribution system comprising:
a process gas generator;
a gas routing mechanism connected to said process gas generation system;
a negative pressure storage tank connected to said gas routing mechanism, said negative pressure storage tank operable to store process gas produced by said process gas generator
a negative pressure line coupled to said negative pressure storage tank;
a plurality of compressors coupled to said negative pressure line, each of the plurality of compressors operable to:
draw process gas from said negative pressure storage tank;
compress said process gas to produce a positive pressure process gas; and
output said positive pressure process gas; and
a positive pressure storage tank associated with each of said plurality of compressors, each positive pressure storage tank in fluid communication with said associated compressor, and wherein each positive pressure storage tank is operable to store said positive pressure process gas received from said associated compressor.

24. The gas distribution system of claim 23, wherein each said positive pressure storage tank is operable to provide said positive pressure process gas to an associated tool.

25. A containment cart comprising:
a liquid-tight outer container configured to store a process gas generation cell containing an electrolyte liquid, said liquid tight outer container sized to contain said process gas generation cell and at least all said electrolyte liquid inside said process gas generation cell, wherein said outer container is formed of a material inert to said electrolyte liquid; and
rolling hardware coupled to the bottom surface of said liquid tight container.

26. The containment cart of claim 25, further comprising a removable lid coupled to said liquid-tight outer container with a liquid-tight seal.

27. The containment cart of claim 25, further comprising one or more supports to support said process gas generation cell within said liquid-tight outer container.

28. The containment cart of claim 25, further comprising a level sensor operable to detect the presence of spilled electrolyte liquid within said liquid tight outer container.

29. The containment cart of claim 28, further comprising a sump configured to channel spilled electrolyte liquid to said level sensor.

30. The containment cart of claim 25, wherein said liquid-tight outer container is formed from stainless steel.

31. A containment cart comprising:
a liquid-tight outer container configured to store a process gas generation cell containing an electrolyte liquid, said liquid tight outer container sized to contain said process gas generation cell and at least all said electrolyte liquid inside said process gas generation cell, wherein said outer container is formed of a material inert to said electrolyte liquid;
rolling hardware coupled to the bottom surface of said liquid tight container;
a removable lid coupled to said liquid-tight outer container with a liquid-tight seal;
one or more supports to support said process gas generation cell within said liquid-tight outer container;
a level sensor operable to detect the presence of spilled electrolyte liquid within said liquid-tight outer container; and
a sump configured to said spilled electrolyte liquid to said level sensor.
